(19) United States
(12) Patent Application Publication
(10) Pub. No.: US 2010/0033755 A1
(43) Pub. Date: Feb. 11, 2010

(54) Image forming apparatus, image processing apparatus, and image forming system

(75) Inventor: Atsushi Kamata, Fukushima (JP)

Correspondence Address: RABIN & Berdo, PC, 1101 14TH STREET, NW, SUITE 500, WASHINGTON, DC, 20005, US

(73) Assignee: OKI DATA CORPORATION

(21) Appl. No.: 12/458,983

(22) Filed: Jul. 29, 2009

(30) Foreign Application Priority Data
Aug. 5, 2008 (JP) 2008-201424

(51) Int. Cl. G06F 3/12

(52) U.S. Cl. 358/1.15

(57) ABSTRACT

An image forming apparatus and an image processing apparatus form N copies of image data that fit a single physical page of print medium. A data receiving section receives print data from an external apparatus. An image reducing section produces a first item of image data based on the print data by reducing a size of an image that corresponds to the print data by a factor of N, N being an integer greater than 1. An image data producing section produces a second item of image data containing N copies of the first item of image data, the N copies of image data fitting a single physical page of print medium. An image printing section prints the second item of image data on the single physical page of print medium.

### BACKGROUND OF THE INVENTION

1. Field of the Invention

The present invention relates to an image forming apparatus, an image processing apparatus, an image forming system, and a method for forming an image.

2. Description of the Related Art

N-up printing is a printing mode in which N individual output pages are formatted side-by-side across a page of print paper. Some conventional image forming apparatuses are capable of performing N-up printing. For example, if images for two pages are to be printed on a single page of print paper, the images for two pages are reduced by a factor of 2, and are then printed side by side on the single page.

Japanese Patent Preliminary Publication NO. 10-100506 discloses a data editing apparatus in which when N-up printing is performed, an image is reduced or not reduced thereby preventing unnecessary reduction or loss of the image.

Conventionally, each image is printed to fit a single physical page of print paper, so that the pages are equal in number to the images. This does not make efficient use of paper.

### SUMMARY OF THE INVENTION

An object of the invention is to economize the amount of print paper.

Another object of the invention is to provide an image forming apparatus in which when a plurality of copies of image data is to be made, the size of each of the image data is reduced and printed on a single page of print paper.

Yet another object of the invention is to provide an image forming apparatus capable of producing an easy-to-carry document.

An image forming apparatus is capable of printing a plurality of copies of images having a reduced-size version of an original image. A data receiving section receives print data from an external apparatus. An image reducing section produces a first item of image data based on the print data by reducing a size of an image that corresponds to the print data by a factor of N, N being an integer greater than 1. An image data producing section produces a second item of image data containing N copies of the first item of image data, the N copies of image data fitting a single physical page of print medium. An image printing section prints the second item of image data on the single physical page of print medium.

Another image processing apparatus is capable of printing a plurality of copies of images having a reduced-size version of an original image. An image reducing section produces a first item of image data based on an original image by reducing a size of the image by a factor of N, N being an integer greater than 1. An image data producing section produces a second item of image data containing N copies of the first image data. A transmitting section transmits the second item of image data to an external apparatus.

An image forming system is capable of printing a plurality of copies of images having a reduced-size version of an original image, and includes an image processing apparatus and an image forming apparatus. An image reducing section produces a first item of image data by reducing a size of an original image by a factor of N, N being an integer greater than 1. An image producing section produces a second item of image data containing N copies of the first item of image data such that the N copies of image data fit a single physical page of print medium. A transmitting section transmits the second item of image data to the image forming apparatus. The image forming apparatus includes a data receiving section and an image forming section. The data receiving section receives the second item of image data from the transmitting section. The image forming section performs printing based on the second item of image data.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 is a block diagram of the printer 1 of a first embodiment;

FIGS. 2A, 2B, 2C, 2D, 2E, and 2F illustrate the lay outs of images in a nCOPYin1 mode for n=2, n=3, n=4, n=6, n=8, and n=9, respectively;

FIGS. 3A and 3B illustrate duplex printing (i.e., P=2) in the nCOPYin1 mode for n=2 and n=4, respectively;

FIG. 4A illustrates the data in the memory;

FIG. 4B illustrates the images in an image data storage section;

FIG. 5 is a flowchart illustrating the operation of the first embodiment;

FIG. 6 is a block diagram illustrating the image forming system of the second embodiment;

FIG. 7A illustrates the data in the memory;

FIG. 7B illustrates the images in an image data storage section;

FIG. 8 is a flowchart illustrating the operation of the personal computer 10 of the second embodiment; and

FIG. 9 is a flowchart illustrating the operation of the printer 20 of the second embodiment.

### DETAILED DESCRIPTION OF THE INVENTION

Embodiments of the invention will be described in detail with reference to the accompanying drawings.

### First Embodiment

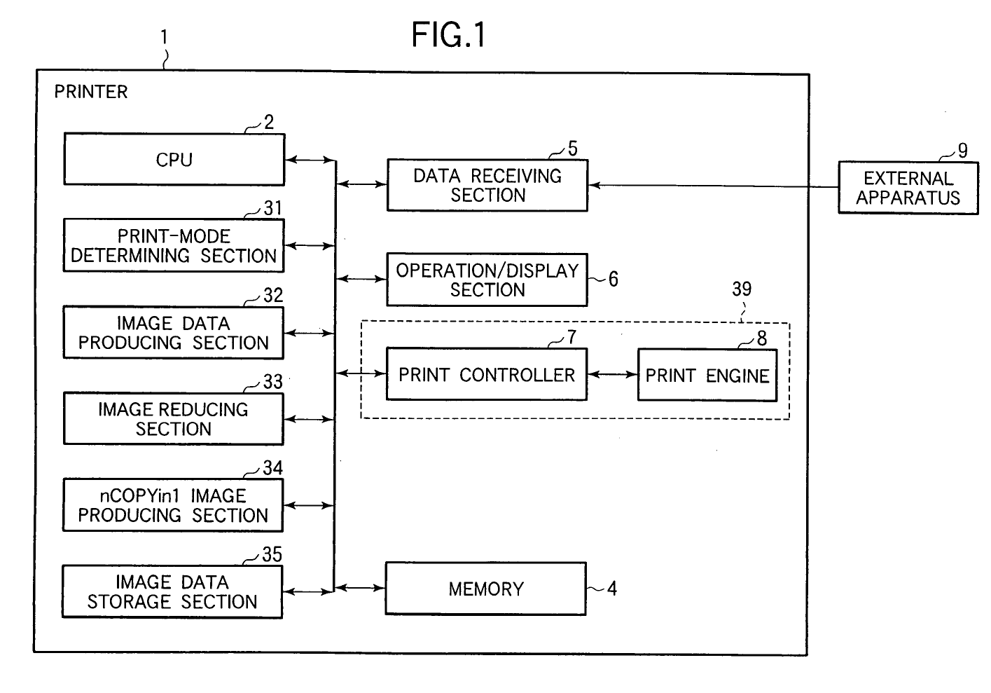

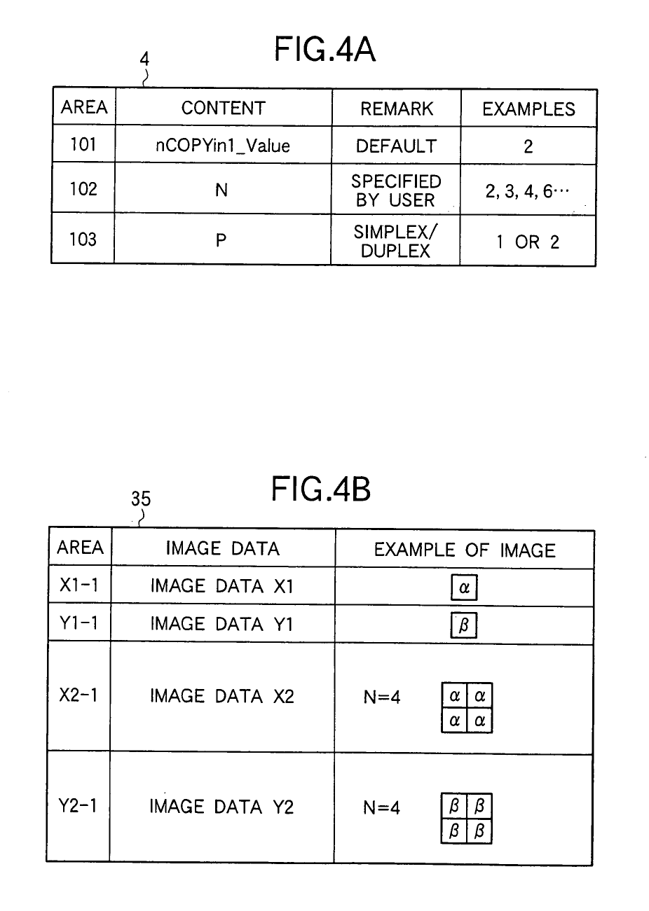

A first embodiment is directed to an image forming apparatus or a printer 1. FIG. 1 is a block diagram of the printer 1 of the first embodiment. The printer 1 incorporates a CPU 2 that performs the overall control of the image forming apparatus. The CPU 2 is a microprocessor and executes previously stored programs in the form of firmware, thereby controlling the entire operation of the image forming apparatus. A memory 4 is implemented with, for example, a RAM, a flash memory, or an HDD, and temporarily stores information necessary for execution of the programs and a variety of settings including a default value or a nCOPYin1_Value, a value N specified by a user (FIG. 4A), and the print mode index P, which will be described later. The value P=1 represents simplex printing and value P=2 represents duplex printing.

An image data receiving section or a data receiving section 5 is implemented with a network card. The data receiving section 5 receives various items of data (i.e., control data and print data) from an external apparatus 9, for example, a personal computer. An operator or user inputs information through an operation/display section 6, which in turn displays the operation status of the printer 1 and various items of information on the printer 1. A specific example of the operation/display section 6 is an operation panel that incorporates switches, LED lamps, and LCD character display. A print controller 7 commands and controls a print engine 8 to print. The print engine 8 performs actual printing under control of the print controller 7. The print controller 7 and print engine 8 constitute an image printing section 39.

An print-mode determining section 31 makes a decision to determine whether printing should be performed in the nCOPYin1 mode in which a plurality of copies of image data for one page is laid out side by side to fit a single physical page of print paper. The print-mode determining section 31 also makes a decision to determine whether the value of P is “1” (simplex printing) or “2” (duplex printing). An image data producing section 32 analyzes the print data received in the data receiving section 5, and generates image data (e.g., bit map data) that can be processed further in the succeeding stage. An image reducing section 33 reduces the image data, generated by the image data producing section 32, into 1/N-size image data that describes an image having a size of 1/N of the image described by the image data generated by the image data producing section 32. N is an integer equal to or greater than 2. An nCOPYin1 image producing section 34 makes N copies of the 1/N-size image data, and then lays out the N copies of the 1/N-size image data to fit a single physical page of a print medium or print paper. The N copies of the 1/N-size image data are called nCOPYin1 image data in this specification. An image data storage section 35 stores the nCOPYin1 image data generated by the nCOPYin1 image producing section 34.

The print-mode determining section 31, image data producing section 32, image reducing section 33, nCOPYin1 image producing section 34, image data storage section 35, are implemented with volatile memories, for example, ROMs, or flash memories, and store firmware that controls the overall operation of the printer 1.

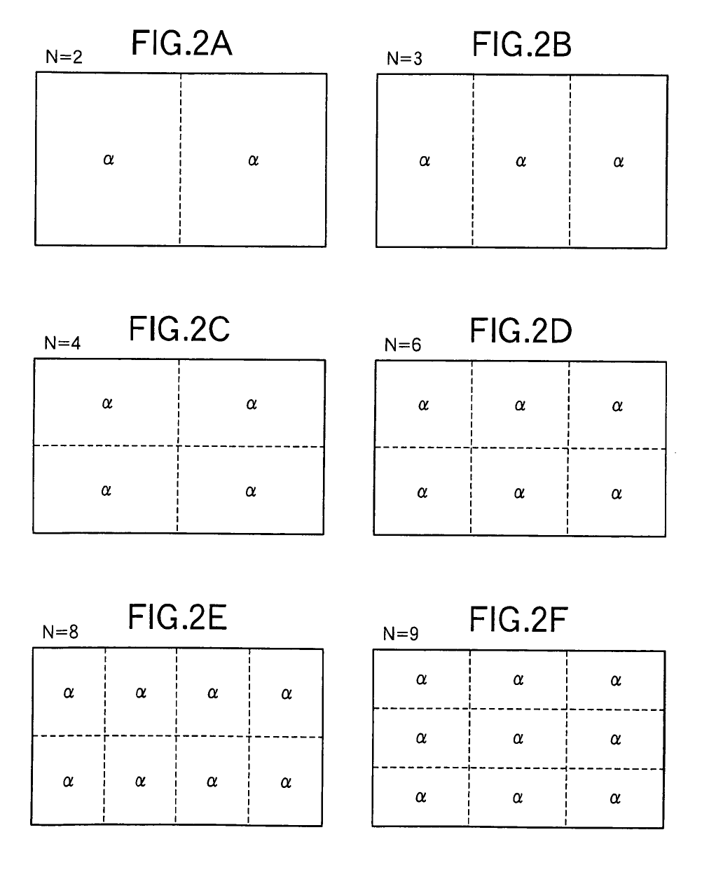

FIGS. 2A-2F illustrate the layouts of images in the nCOPYin1 mode for N=2, N=3, N=4, N=6, N=8, and N=9, respectively. In this specification, the term “nCOPYin1 mode” refers to a printing mode in which a plurality of copies of an image (α) for one page reduced in size are fitted to a single physical page of print paper.

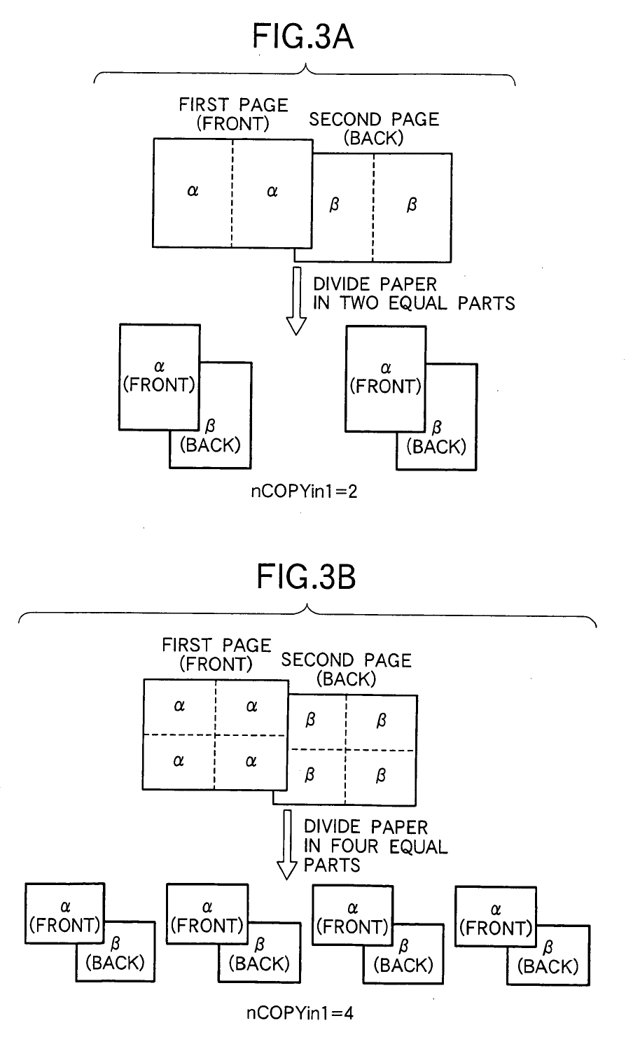

FIGS. 3A and 3B illustrate duplex printing (i.e., P=2) in the nCOPYin1 mode for n=2 and n=4, respectively. Referring to FIG. 3A, two copies of 1/N-size image data for two pages are made, the first page of the two pages having the image α and the second page of the two pages having an image β. Then, two copies of 1/N-size image data that describes the image α are laid out on the front side of a single physical sheet of print paper, and two copies of 1/N-size image data that describes the image β are laid out on the back side. Then, the printed single page is cut into two equal parts.

Referring to FIG. 3B, four copies of 1/N-size image data for each of two pages are made, the first page of the two pages having the image α and the second page of the two pages having the image β. Then, the four copies of 1/N-size image data describing the image α are laid out on the front side of a single physical sheet of print paper and four copies of 1/N-size image data of the image β on the back side. The image α is printed on the front page, and the image β is printed on the back page. Then, the printed single page is cut into four equal parts. In this manner, a piece of information on notes, events, or projects may be printed on both sides of the print paper. Then, the printed information in the form of hand-outs may be distributed among involved individuals.

FIG. 4A illustrates the data stored in the memory 4 and FIG. 4B illustrates the images in the image data storage section 35. Referring to FIG. 4A, an area 101 holds a default value or the nCOPYin1-Value previously stored in the printer 1. For example, the area 101 holds “2.” An area 102 holds the value of N specified by the user for the nCOPYin1 mode. If the user does not specify the value of N, the default value is valid. When the user specifies the value of N, which is an integer equal to or greater than 2, the area 102 holds the value of N, which is an integer equal to or greater than 2. As is clear from FIGS. 2A-2F, the value of N specified by the user is one of “2,” “3,” “4,” “6,” “8,” and “9,” An area 103 holds the value of the print mode index P for the image data. If P is “1,” the image data is for simplex printing. If P is “2,” the image data is for duplex printing.

Referring to FIG. 4B, if the image data is for simplex printing, a first item of image data or 1/N-size image data X1 that describes the image α is stored into an area X1-1, and another first item of image data or 1/N-size image data Y1 that describes the image β for the back page is stored in an area Y1-1. An area X2-1 holds the N copies of 1/N-size image data X1. For example, if N=4 and the image data is for simplex printing, then the area X2-1 holds four copies of the 1/N-size image data X1. The four copies of the 1/N-size image data X1 are laid out to fit a single physical page of print paper. A group of N copies of the 1/N-size image data X1 as a whole is called a second item of image data or nCOPYin1 image data X2 in this specification.

If N=4 and the image data is for duplex printing, then the area Y2-1 holds four copies of the 1/N-size image data Y1. The four copies of the 1/N-size image data Y1 are laid out to fit a single physical page of print paper. A group of N copies of the 1/N-size image data Y1 as a whole is called another second item of image data or nCOPYin1 image data Y2 in this specification.

### {Operation}

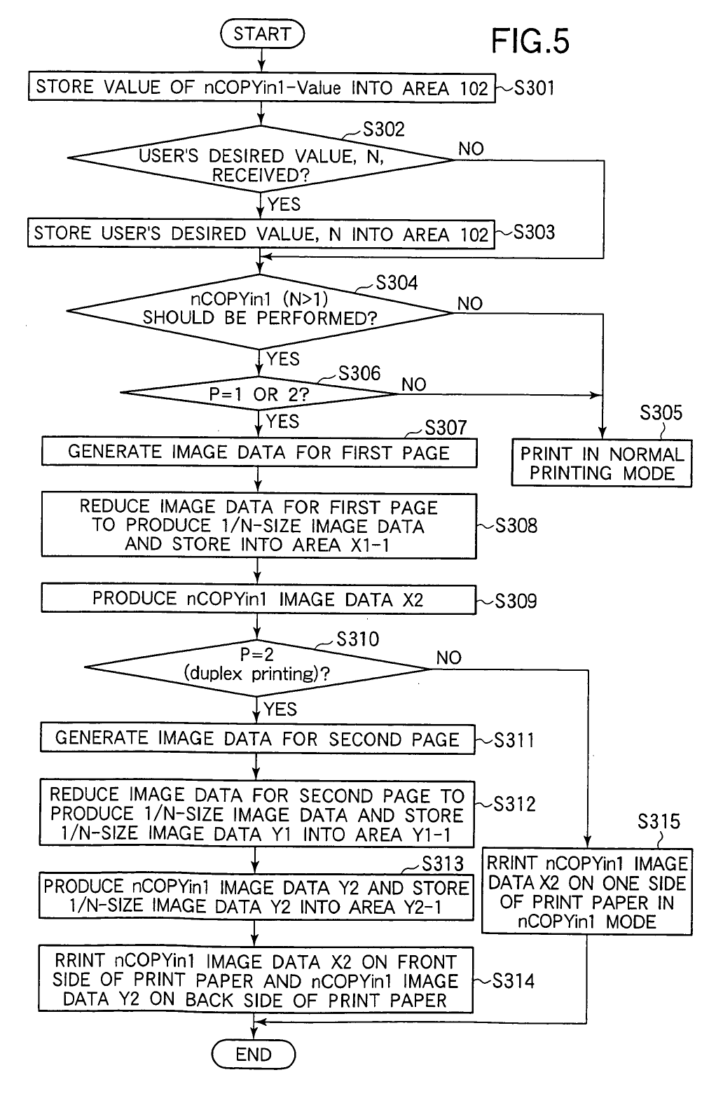

The operation of the first embodiment will be described. FIG. 5 is a flowchart illustrating the operation of the first embodiment. When print data is received from an external apparatus 9, the CPU 2 reads the default value of the nCOPYin1-Value, which is “2” and has been previously stored in the printer 1, from the area 101 of the memory 4. Then, the CPU 2 stores the value of the nCOPYin1-Value into the area 102 (S301).

Then, the CPU 2 makes a decision to determine whether the user's desired value, N, for the nCOPYin1 has been received together with information on the various settings of the print data (S302). If the user's desired value, N, for the nCOPYin1 mode has been received, the user's desired value, N, is stored in the area 102 of the memory 4 (S303).

The CPU 2 controls the print-mode determining section 31 to determine whether the user's desired value, N, greater than 1 has been received (S304). If the user's desired value, N, has not been received, normal printing is performed. The print-mode determining section 31 makes a decision to determine whether the value of P is “1” or “2.” If the value of P is neither “1” nor “2,” the print data is printed in the normal printing mode instead of in the nCOPYin1 mode (S306, S305).

The CPU 2 controls the image data producing section 32 to analyze the received print data for the first page, and then generates image data for the first page (S307). Then, the CPU 2 controls the image reducing section 33 to reduce the image data for the first page generated at step S307 by a factor of N, thereby producing 1/N-size image data X1 (S308). Then, the CPU 2 controls the image data storage section 35 to store the 1/N-size image data X1 for the first page into the area X1-1 (S308).

Then, the CPU 2 controls the nCOPYin1 image producing section 34 to lay out the N copies of the 1/N-size image data X1 generated at step S308 to fit a single page of print paper, thereby producing the nCOPYin1 image data X2. If N=2, then the image a of the first page shown in FIG. 3A is laid out. If N=4, then the image a of the first page shown in FIG. 3B is laid out. The thus generated image data for the nCOPYin1 mode, i.e., nCOPYin1 image data X2 for the first page is stored into the area X2-1 (S309).

The CPU 2 controls the nCOPYin1 determining section 31 to determine whether the value of P is 2 (duplex printing) (S310). If the image data is only for one page (P is not 2), the nCOPYin1 image data X2 is printed on one side of the print paper in the nCOPYin1 mode (S315).

The CPU 2 controls the image data producing section 32 to analyze the print data for the received second page, and then generates image data for the second page (S311). Then, the CPU 2 controls the image reducing section 33 to reduce the thus generated image data by a factor of N, thereby producing 1/N-size image data Y1. Then, the CPU 2 stores the thus obtained 1/N-size image data Y1 into the area Y1-1 (S312).

The CPU 2 controls the nCOPYin1 image producing section 34 to lay out the N copies of the 1/N-size image data Y1 generated at step S312 to fit a single physical page of the print paper, thereby producing the nCOPYin1 image data Y2. Here, the 1/N-size image data Y1 describes the image β for the back page as shown in FIG. 3A for N=2, and the image β for the back page as shown in FIG. 3B for N=4. Then, the CPU 2 controls the image data storage section 35 to store the nCOPYin1 image data Y2 into the area Y2-1 (S313). The CPU 2 sends the nCOPYin1 image data X2 and the nCOPYin1 image data Y2 stored at S309 and S313, respectively, to the print engine 8. The print engine 8 is capable of performing duplex printing, and prints the nCOPYin1 image data X2 on the front side of a single page of print paper and the nCOPYin1 image data Y2 on the back side (S314).

Traditionally, images are simply printed on a plurality of pages of print paper before they are distributed. Therefore, the printed pages are equal to the printed images in number. This leads to inefficient use of paper, especially if the reduced images are sufficient for practical use.

Conversely, in the first embodiment, a plurality of copies of image data of the print data is printed on a single page of print paper. Then, the printed paper is cut into smaller equal parts as shown in, for example, FIGS. 2A-2F. Thus, each sheet on which the original image data is printed in a reduced size may be distributed to a plurality of individuals. This way of printing is effective in saving the number of sheets of print paper, thus achieving cost reduction and providing compact sized and easy-to-handle printouts.

### Second Embodiment

A second embodiment is directed to an image forming system comprising a personal computer 10 and a printer 20. The personal computer 10 generates image data for an nCOPYin1 mode in which a plurality of copies of image data for one page reduced in size is printed on a single physical page of paper by laying out the plurality of copies of image data to fit the single physical page. The image data is then transmitted from the personal computer 10 through a data transmitting section 10 to the printer 20. A data receiving section 25 of the printer 20 receives the image data for the nCOPYin1 mode from the personal computer 10. A print engine 28 prints the image data in the nCOPYin1 mode.

### {Computer}

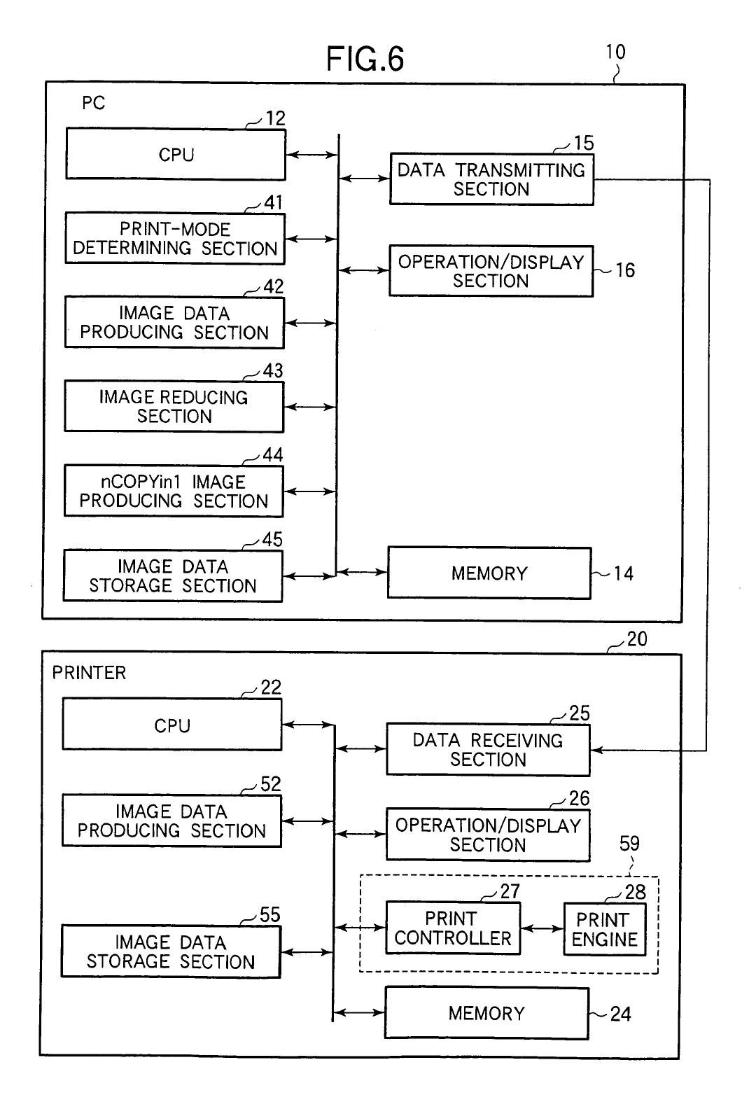

FIG. 6 is a block diagram illustrating the image forming system of the second embodiment. Referring to FIG. 6, the personal computer 10 includes a CPU 12 implemented with, for example, a microprocessor. The CPU 12 executes programs implemented in firmware and previously stored in the personal computer 10 to perform the overall control of the personal computer 10. A memory 14 is implemented with, for example, a RAM, a flash memory or an HDD, and temporarily stores information necessary for executing the programs. The memory 14 also stores various settings including a default value of an nCOPYin1_Value, a user's desired value of N, and the value of P. The value P=1 represents simplex printing and the value P=2 represents duplex printing. An image transmitting section or a data transmitting section 15 transmits the image data for the nCOPYin1 mode and other control data necessary for performing printing in the nCOPYin1 mode, stored in an image data storage section 45, to the printer 20. An operation/display section 16 includes a key board and a monitor. A user inputs various items of information including a request for entering the nCOPYin1 mode through an operation/display section 16, which in turn displays on its monitor the operation status of the printer 1 and the various items of information.

A print-mode determining section 41 makes a decision to determine whether a request for the nCOPYin1 mode has been received. The print-mode determining section 41 also makes a decision to determine whether the value of P is “1” (i.e., simplex printing) or “2” (i.e., duplex printing). An image data producing section 42 analyzes the print data, created by an application program (not shown) within the personal computer 10, to produce image data (e.g., bit map data) that can be processed further in the succeeding stages of data processing. An image reducing section 43 reduces the image data generated by the image data producing section 42, the image data being reduced by a factor of N, i.e., into a 1/N-size image data which will be described later. An nCOPYin1 image producing section 44 makes N copies of the 1/N-size image data, and then lays out the N copies of the 1/N-size image data to fit a single physical page of print paper. A group of N copies of the 1/N-size image data as a whole is called nCOPYin1 image data in this specification. An image data storage section 45 holds the nCOPYin1 image data generated by the nCOPYin1 image producing section 44.

The print-mode determining section 41, image data producing section 42, image reducing section 43, nCOPYin1 image producing section 44, image data storage section 45, and memory 14 are implemented with a non-volatile memory device, for example, a flash memory, and are configured to be firmware that performs the overall control of the computer 10.

### {Printer}

The printer 20 includes the CPU 22 that controls the overall operation of the printer 20. The CPU 22 is implemented with, for example, a microprocessor, and executes programs in the form of firmware previously stored in the printer 20 to perform the overall control of the printer 20. A memory 24 is implemented with, for example, a ROM, a RAM, or a flash memory, or an HDD, and temporarily stores information necessary for executing the programs. The data receiving section 25 is implemented with, for example, a network card, and receives the nCOPYin1 image data X2 and nCOPYin1 image data Y2 or only nCOPYin1 image data X2 and other control data transmitted from the data transmitting section 15 of the personal computer 10.

An operation/display section 26 includes an operation panel that incorporates, for example, switches, LED lamps, and an LCD display. A user inputs information into the operation/display section 26, which in turn displays the operation status of the printer 20 and the various items of information to the user. A print controller 27 controls the print engine 28 to print. The print engine 28 performs actual printing under control of print controller 27. The print controller 27 and print engine 28 constitute an image printing section 59.

An image data producing section 52 analyzes the nCOPYin1 image data (i.e., nCOPYin1 image data X2 and nCOPYin1 image data Y2) received in the data receiving section 25. Then, the image data producing section 52 processes these items of image data into suitable data form that can be processed in the succeeding stage. An image data storage section 55 temporarily stores the nCOPYin1 image data X2 and nCOPYin1 image data Y2. The image data producing section 52, image data storage section 55, memory area 24, and data receiving section 25 are implemented with a non-volatile memory device, for example, a flash memory that holds firmware for controlling the overall operation of the printer 20.

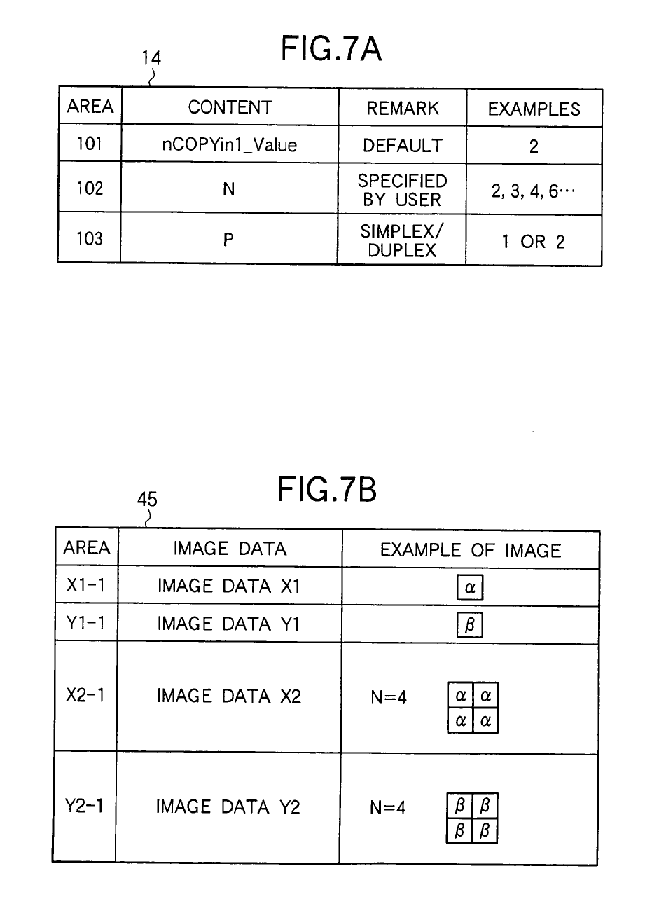

FIG. 7A illustrates the data stored in the memory 4 and FIG. 7B illustrates the images in the image data storage section 35.

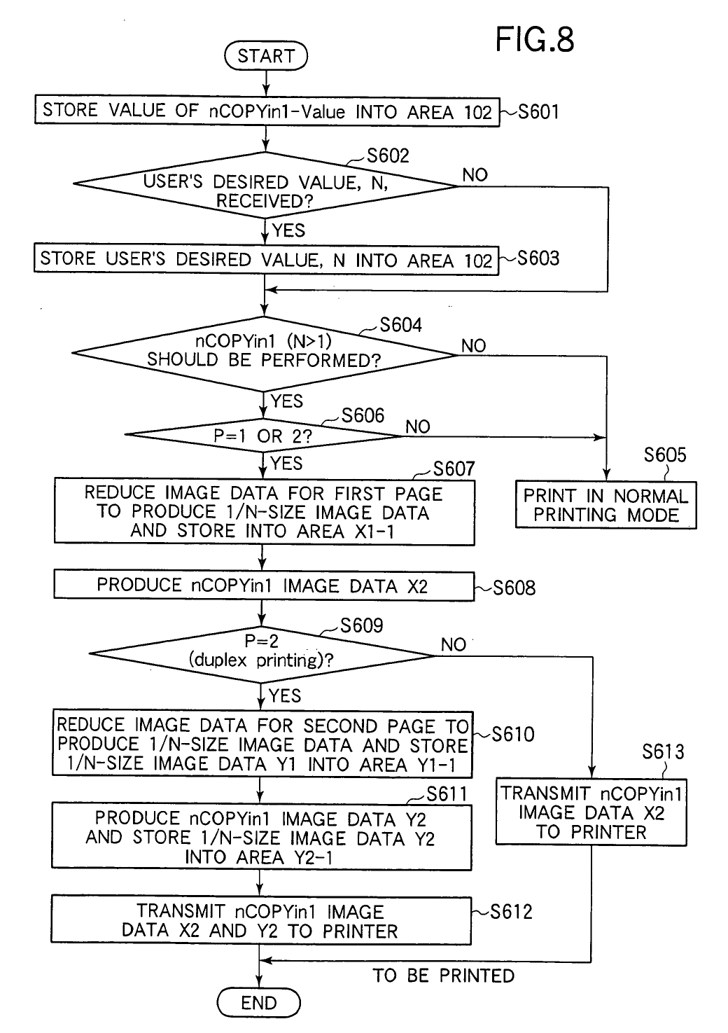

FIG. 8 is a flowchart illustrating the operation of the personal computer 10 of the second embodiment. When the print data created by an application (not shown) within the personal computer 10 is transmitted to the printer 20, the CPU 12 reads the default value of the nCOPYin1_Value from an area 101 of the memory 14, and stores the value to an area 102 (S601).

The CPU 12 makes a decision to determine whether the user's desired value of nCOPYin1, N, has been received among other items of information on the print data (S602). If the user's desired value, N, for the nCOPYin1 mode has been received, the user's desired value, N, is stored into the area 102 of the memory 14.

The CPU 12 controls the nCOPYin1 determining section 41 to determine whether the user's desired value, N, equal to or greater than “2” has been received (S604). If the value of N is larger than 1, it is determined that the user's desired value, N, has been received. If the user's desired value, N, has not been received, it is determined that printing should be performed in the normal printing mode rather than in the nCOPYin1 mode. The nCOPYin1 determining section 41 makes a decision to determine whether the value of P is “1” (simplex printing) or “2” (duplex printing). If the value of P is neither “1” nor “2,” printing is performed in the normal printing mode rather than in the nCOPYin1 mode (S606, S605).

The CPU 12 controls the image data producing section 42 to analyze the received print data for the first page, and then generates the image data for the first page. Then, the CPU 12 controls the image reducing section 43 to reduce the image data for the first page by a factor of N, thereby producing 1/N-size image data X1. Then, the CPU 12 controls the image data storage section 45 to store the 1/N-size image data X1 into the area X1-1 (S607).

Then, the CPU 12 controls the nCOPYin1 image producing section 44 to lay out N copies of the 1/N-size image data X1 to fit a single physical page of print paper. The N copies of the 1/N-size image data X1 that fit a single physical page of print paper is called nCOPYin1 image data X2 in this specification. The thus generated nCOPYin1 image data X2 is stored into the area X2-1 for the first page of the memory 14 (S608).

The CPU 12 controls the print-mode determining section 41 to determine whether the value of P is “2” (S609). If the image data is only for one page (NO at step S609), the data transmitting section 15 transmits the image data X1 to the printer 20 (S613).

The CPU 12 controls the image data producing section 42 to analyze the received print data for the second page, and then generates image data for the second page. The CPU 2 controls the image reducing section 43 to reduce the image data for the second page by a factor of N, thereby producing 1/N-size image data Y1. Then, the CPU 12 controls the image data storage section 45 to store the 1/N-size image data Y1 into an area Y1-1 (S610).

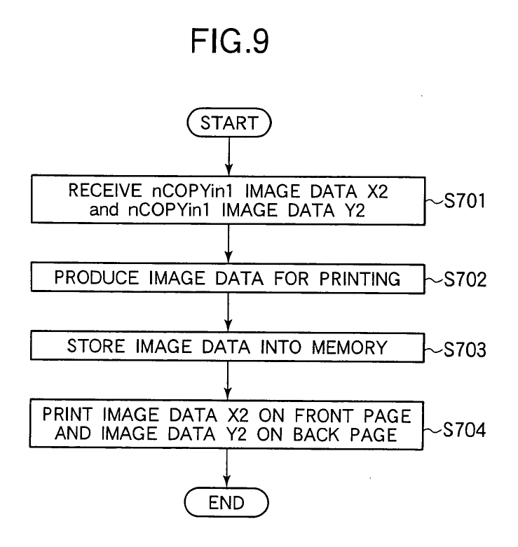

The CPU 12 controls the nCOPYin1 image producing section 44 to lay out N copies of the image data Y1 to fit a single physical page of printer paper. A group of N copies of the 1/N-size image data Y1 that fit a single physical page of print paper is called nCOPYin1 image data Y2 in this specification. Then, the CPU 12 controls the image data storage section 45 to store the nCOPYin1 image data Y2 into an area Y2-1 (S611). The data transmitting section 15 transmits the nCOPYin1 image data X2 and nCOPYin1 image data Y2 to the data receiving section 25 of the printer 20. (S612) FIG. 9 is a flowchart illustrating the operation of the printer 20 of the second embodiment. The CPU 22 controls the data receiving section 25 to receive image data for the nCOPYin1 mode, i.e., nCOPYin1 image data X2 and nCOPYin1 image data Y2 or only the nCOPYin1 image data X2 from the data transmitting section 15 of the computer 10 (S701). The received image data contains the 1/N-size image data X2 and 1/N-size image data Y2 if the image data is for duplex printing, or only the 1/N-size image data X2 if the image data is for simplex printing. Then, the CPU 22 controls the image data producing section 52 to analyze the received image data, thereby producing image data in a data format that can be processed subsequently in the printer 20 (S702) Then, the CPU 22 controls the image data storage section 55 to store the analyzed image data therein (S703).

The CPU 22 controls the print controller 27 to command the print engine 28 to perform printing of the image data produced by the image data producing section 52 (S704). In this manner, the nCOPYin1 image data X2 (four copies of the image “a” if N=4) is printed on the front side of the print paper if the image data is for simplex printing.

Likewise, the nCOPYin1 image data Y2 (four copies of the image “β” if N=4) is printed on the back side of the print paper if the nCOPYin1 image data Y2 is available. Then, the thus printed paper is cut into equal parts, which in turn are distributed to involved individuals.

As described above, if the personal computer 10 of the image forming system supports raster image processing (RIP), the print data for one or two pages may be reduced in size so that the image data may be printed on print paper in duplex printing, thereby allowing printing of image data for multiple pages on a single sheet of print paper, i.e., in the nCOPYin1 mode. This saves the printing cost and improves the portability and ease of handling of the printouts.

The method of printing image data of the first and second embodiments may be implemented in the form of an image forming program, which in turn is executed in a computer. The present invention may be practiced in a computer-readable recording medium on which the image forming program has been stored.

What is claimed is:

1. An image forming apparatus, comprising:
a data receiving section that receives print data from an external apparatus;
an image reducing section that produces a first item of image data based on the print data by reducing a size of an image that corresponds to the print data by a factor of N, N being an integer greater than 1;
an image data producing section that produces a second item of image data containing N copies of the first item of image data, the N copies of image data fitting a single physical page of print medium; and
an image printing section that prints the second item of image data on the single physical page of print medium.

2. The image forming apparatus according to claim 1, wherein said image reducing section produces the N copies of the first item of image data.

3. The image forming apparatus according to claim 1, further comprising a determining section that determines whether a request has been received, the request being such that the N copies of the first item of image data are laid out to fit the single physical page of print paper.

4. The image forming apparatus according to claim 1, wherein the first item of image data describes a first image and a second image, wherein said image printing section prints the first image on a first side of the print paper and the second image on a second side of the print paper.

5. The image forming apparatus according to claim 1, wherein the N is an integer selected from the group consisting of 2, 3, 4, 6, 8, and 9.

6. An image processing apparatus, comprising:
an image reducing section that produces a first item of image data based on an original image by reducing a size of the image by a factor of N, N being an integer greater than 1;
an image data producing section that produces a second item of image data containing N copies of the first image data; and
a transmitting section that transmits the second item of image data to an external apparatus.

7. The image forming apparatus according to claim 6, wherein said image reducing section produces the N copies of the first item of image data.

8. The image forming apparatus according to claim 6, further comprising a determining section that determines whether a request has been received, the request being such that the N copies of the first item of image data are laid out to fit the single physical page of print paper.

9. The image forming apparatus according to claim 6, wherein said image producing section comprises an image data storing section, wherein said image producing section produces a first part of the second item of image data that should be printed on a first side of print paper, a second part of the second item of image data that should be printed on a second side of print paper, and said image data storing section stores therein the first part of the second item of image data and the second part of the second item of image data.

10. The image forming apparatus according to claim 6, wherein the N is an integer selected from the group consisting of 2, 3, 4, 6, 8, and 9.

11. An image forming system, comprising an image processing apparatus and an image forming apparatus, wherein the image processing apparatus comprises:
an image reducing section that produces a first item of image data by reducing a size of an original image by a factor of N, N being an integer greater than 1;
an image producing section that produces a second item of image data containing N copies of the first item of image data such that the N copies of image data fit a single physical page of print medium;
a transmitting section that transmits the second item of image data to the image forming apparatus;
wherein the image forming apparatus comprises:
a data receiving section that receives the second item of image data from said transmitting section; and
an image forming section that performs printing based on the second item of image data.

12. The image forming apparatus according to-claim 11, wherein said image reducing section produces the N copies of the first item of image data.

13. The image forming apparatus according to claim 11, further comprising a determining section that determines whether a request has been received, the request being such that the N copies of the first item of image data are laid out to fit the single page of print paper.

14. The image forming apparatus according to claim 11, wherein said image producing section comprises an image data storing section that stores a first part of the second item of image data that should be printed on a first side of print paper, a second part of the second item of image data that should be printed on a second side of print paper, and stores the first part of the first item of image data and the second part of the second item of image data therein.

15. The image forming apparatus according to claim 11, wherein the N is an integer selected from the group consisting of 2, 3, 4, 6, 8, and 9.
